(19) United States
(12) Patent Application Publication
(10) Pub. No.: US 2014/0118198 A1
(43) Pub. Date: May 1, 2014

(54) ELECTRONIC APPARATUS

(71) Applicant: KABUSHIKI KAISHA TOSHIBA, Tokyo (JP)

(72) Inventors: Satoshi Kawashimo, Fussa-shi (JP); Akihiro Tsujimura, Kokubunji-shi (JP)

(73) Assignee: KABUSHIKI KAISHA TOSHIBA, Tokyo (JP)

(21) Appl. No.: 13/975,582

(22) Filed: Aug. 26, 2013

(30) Foreign Application Priority Data
Oct. 25, 2012 (JP) 2012-235991

(51) Int. Cl. H01Q 1/22

(52) U.S. Cl. CPC H01Q 1/22
USPC 343/702

(57) ABSTRACT

According to one embodiment, an electronic apparatus includes a housing, a component, a near-field wireless antenna, and a conductive sidewall. The housing includes a non-conductive portion. The component is in the housing and includes a metal portion. The near-field wireless antenna faces the non-conductive portion in the housing and is located between the non-conductive portion and the component. The conductive sidewall is in at least a portion of a periphery of the antenna.

### CROSS-REFERENCE TO RELATED APPLICATIONS

This application is based upon and claims the benefit of priority from Japanese Patent Application No. 2012-235991, filed Oct. 25, 2012, the entire contents of which are incorporated herein by reference.

### FIELD

Embodiments described herein relate generally to electronic apparatuses.

### BACKGROUND

An electronic apparatus has been known which includes a near-field wireless communication antenna.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an electronic apparatus according to a first embodiment;

FIG. 2 is an exemplary cross-sectional view illustrating the electronic apparatus taken along the line F2-F2 of FIG. 1;

FIG. 3 is an exemplary cross-sectional view illustrating the electronic apparatus taken along the line F3-F3 of FIG. 1;

FIG. 4 is an exemplary plan view illustrating a middle frame illustrated in FIG. 2;

FIG. 5 is an exemplary bottom view illustrating the inner surfaces of an upper cover and the middle frame illustrated in FIG. 2;

FIG. 6 is an exemplary cross-sectional view schematically illustrating the inside of the electronic apparatus illustrated in FIG. 1;

FIG. 7 is an exemplary bottom view illustrating the inner surfaces of an upper cover and a middle frame according to a second embodiment;

FIG. 8 is an exemplary cross-sectional view schematically illustrating the inside of the electronic apparatus according to the second embodiment; and

FIG. 9 is a plan view illustrating a middle frame according to a third embodiment.

### DETAILED DESCRIPTION

Various embodiments will be described hereinafter with reference to the accompanying drawings.

In general, according to one embodiment, an electronic apparatus comprises a housing, a component, a near-field wireless antenna, and a conductive sidewall. The housing comprises a non-conductive portion. The component is in the housing and comprises a metal portion. The near-field wireless antenna faces the non-conductive portion in the housing and is located between the non-conductive portion and the component. The conductive sidewall is in at least a portion of a periphery of the antenna.

In this specification, some components are expressed by two or more terms. Those terms are just examples. Those components may be further expressed by another or other terms. And the other components which are not expressed by two or more terms may be expressed by another or other terms.

Hereinafter, embodiments will be described with reference to the accompanying drawings.

### First Embodiment

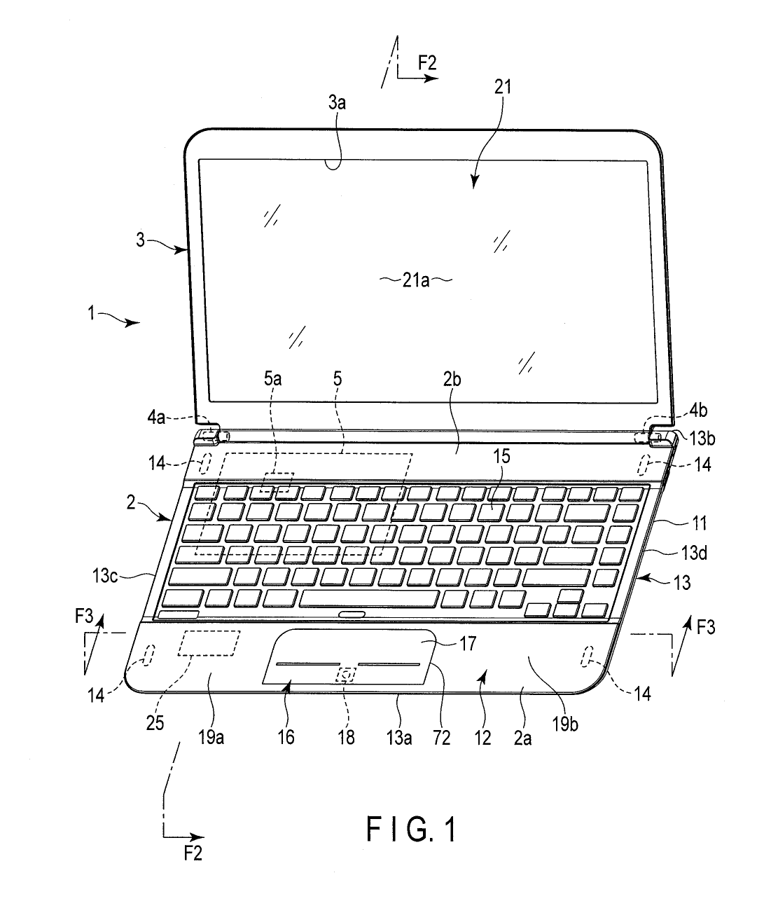

First, an electronic apparatus 1 according to a first embodiment will be described with reference to FIGS. 1 to 6. As illustrated in FIG. 1, the electronic apparatus 1 according to this embodiment is, for example, a notebook portable computer. The electronic apparatus to which the embodiments can be applied is not limited to the above-mentioned example, but the embodiments can be widely applied to various kinds of electronic apparatuses, such as tablet personal computers (i.e., tablet terminals), television, mobile phones (including smart phones), and game machines.

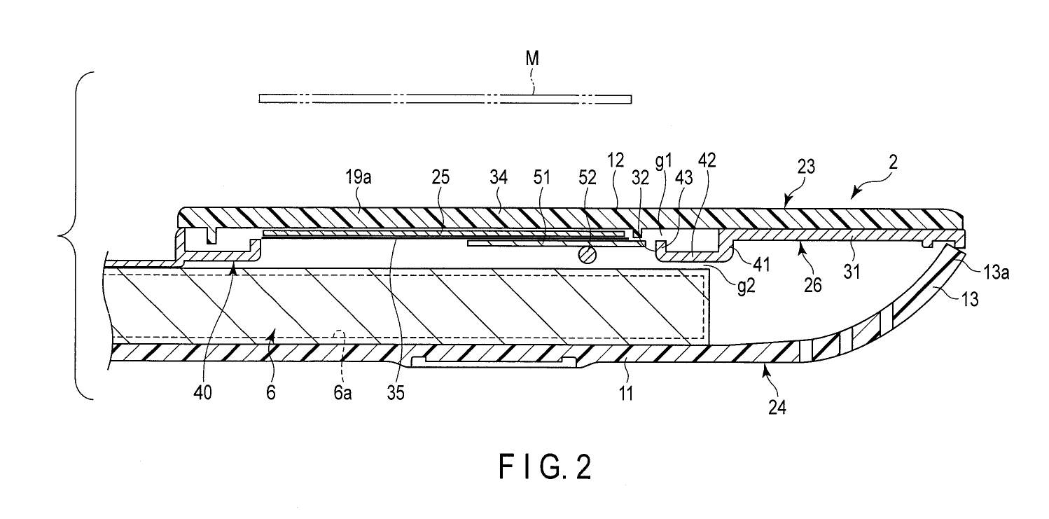

As illustrated in FIG. 1, the electronic apparatus 1 includes a first housing 2, a second housing 3, and hinges 4a and 4b. The first housing 2 is, for example, a main housing. For example, a circuit board 5 and a battery 6 (see FIG. 2) are accommodated in the first housing 2.

The first housing 2 includes a lower wall 11 (i.e., bottom wall or a first wall), an upper wall 12 (i.e., second wall), and a circumferential wall 13 (i.e., third wall) and has a flat box shape. The lower wall 11 faces a desk surface (i.e., external mounting surface), for example, when the electronic apparatus 1 is placed on a desk. The lower wall 11 includes, for example, a plurality of legs 14 (i.e., supporter). When the electronic apparatus 1 is placed on the desk, the legs 14 come into contact with the desk surface and support the electronic apparatus 1.

The upper wall 12 is opposite to the lower wall 11. The upper wall 12 extends substantially in parallel to, for example, the lower wall 11. For example, a keyboard 15 and a touchpad unit 16 are provided on the upper wall 12. The keyboard 15 is disposed substantially at the center of the upper wall 12. The keyboard 15 is an example of a “first input unit”. The first input unit is not limited to the keyboard 15, but may be, for example, a touch panel (i.e., touch sensor) or other input devices.

The touchpad unit 16 (i.e., click pad unit) is provided in front of the keyboard 15. The touchpad unit 16 is an example of a “second input unit”. The touchpad unit 16 includes, for example, a touchpad 17, which is a pointing device, and a button module 18 (i.e., click button).

The button module 18 according to this embodiment is provided in the touchpad 17. The button module 18 includes, for example, a switch and a receiving portion which faces the switch. The switch is provided in the touchpad 17 or on the rear surface thereof. When the touchpad 17 is pressed, the switch gets lower toward the receiving portion, comes into contact with the receiving portion, and is operated. In addition, the button module 18 may include a button (e.g., push button) which is exposed to the outside of the first housing 2 and a switch which is operated by the button.

The circumferential wall 13 includes a portion which extends in a direction intersecting (e.g., substantially perpendicular to) the upper wall 12 and the lower wall 11 and connects the edge of the upper wall 12 and the edge of the lower wall 11. The circumferential wall 13 includes a front wall 13a, a rear wall 13b, a first sidewall 13c (e.g., a left wall), and a second sidewall 13d (e.g., a right wall).

The first housing 2 includes a first end 2a and a second end 2b. The first end 2a is, for example, the front end. The second end 2b is, for example, the rear end and is opposite to the first end 2a. The hinges 4a and 4b are connected to the second end 2b. In the specification, the side close to the user is defined as the “front side” and the side away from the user is defined as the “rear side” when viewed the electronic apparatus placed on the desk surface. In addition, the left and right sides are defined as viewed from the user.

The front wall 13a is disposed at the first end 2a of the first housing 2 and extends in the longitudinal direction of the first housing 2. The rear wall 13b is opposite to the front wall 13a and extends substantially in parallel to the front wall 13a. The first sidewall 13c and the second sidewall 13d extend in a direction intersecting (e.g., substantially perpendicular to) the front wall 13a and the rear wall 13b and connect the front wall 13a and the rear wall 13b, respectively.

As illustrated in FIG. 1, the touchpad unit 16 is disposed between the keyboard 15 and the front wall 13a. The first housing 2 includes palm rests 19a and 19b which are provided between the touchpad unit 16 and the first sidewall 13c and between the touchpad unit 16 and the second sidewall 13d.

As illustrated in FIG. 1, in this embodiment, the circuit board 5 is provided at a position that shifts from the center of the first housing 2 to the rear wall 13b. The circuit board 5 includes, for example, a heat generating component 5a, such as a CPU. Therefore, the circuit board 5 is more likely to be heated than the battery 6. The circuit board 5 is arranged at a position that deviates from the lower sides of the palm rests 19a and 19b.

The circuit board 5 is an example of a “noise (e.g., radio wave noise) generating component”. The “noise generating component” is not limited to the circuit board 5, but may be various modules or electronic components accommodated in the first housing 2.

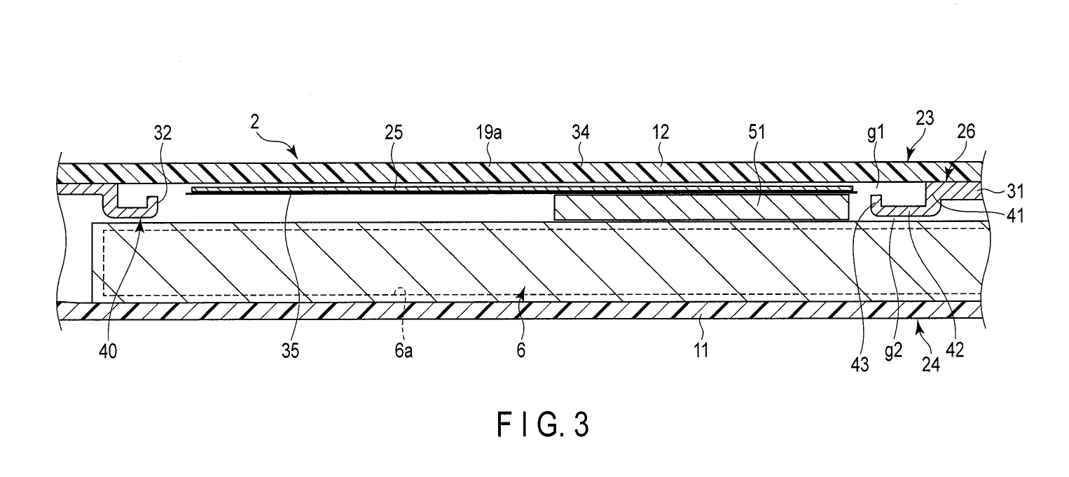

FIGS. 2 and 3 are cross-sectional views illustrating the first housing 2. As illustrated in FIGS. 2 and 3, the battery 6 (i.e., a battery pack or a battery unit) is provided below the palm rests 19a and 19b. The battery 6 has, for example, a flat box shape. The battery 6 includes, for example, a plurality of cells and a metal case 6a (i.e., a battery case or a metal portion) having the cells accommodated therein. The battery 6 is an example of a “component (i.e., member) including a metal portion”. The “component (i.e., member) including the metal portion” is not limited to the battery 6, but may be a hard disk drive (HDD), an optical disk drive (ODD), a circuit board, or various other modules, which will be described below.

The second housing 3 is, for example, a display housing. A display 21 (i.e., a display device or a display module) is accommodated in the second housing 3. The display 21 includes a display screen 21a. An opening 3a through which the display screen 21a is exposed is provided in the front wall of the second housing 3.

The hinges 4a and 4b connect the end of the first housing 2 and the end of the second housing 3 such that the first and second housings can be rotated (i.e., opened) relative to each other. In this way, the electronic apparatus 1 can be opened and folded. The electronic apparatus 1 can be deformed between a first state in which the first housing 2 and the second housing 3 overlap each other and a second state in which the first housing 2 and the second housing 3 are opened and the keyboard 15, the touchpad unit 16, and the display screen 21a are exposed to the outside.

Next, the structure of the first housing 2 (hereinafter, referred to as the housing 2) will be described in detail.

As illustrated in FIGS. 2 and 3, the housing 2 includes an upper cover 23 (i.e., a base cover, a first cover, or a first member) and a lower cover 24 (i.e., a bottom cover, a second cover, or a second member). The lower cover 24 includes, for example, the lower wall 11 and the circumferential wall 13 and has a bowl shape with an open top. The upper cover 23 includes the upper wall 12.

The upper cover 23 and the lower cover 24 are combined with each other to form an example of the housing 2. In this embodiment, each of the upper cover 23 and the lower cover 24 is made of, for example, a synthetic resin. For example, conductive coating, plating, or metal foil attachment is performed for the inner surfaces of the upper cover 23 and the lower cover 24 except for a region facing an antenna 25, which will be described below, such that the inner surfaces have conductivity. Instead, the upper cover 23 and the lower cover 24 may be made of metal and only the region facing the antenna 25 may be a separate member made of a synthetic resin.

As illustrated in FIGS. 2 and 3, the housing 2 is provided with a middle frame 26 (i.e., inner frame). The middle frame 26 is made of metal (e.g., a magnesium alloy) and has conductivity. The middle frame 26 is an example of a “reinforcing member (i.e., a reinforcing portion or a metal member)”. The middle frame 26 is attached to the inner surface of the upper wall 12 and improves the rigidity of the housing 2. The middle frame 26 includes a supporting wall 31 which extends along the inner surface of the upper wall 12 (i.e., along the inner surface of the housing 2).

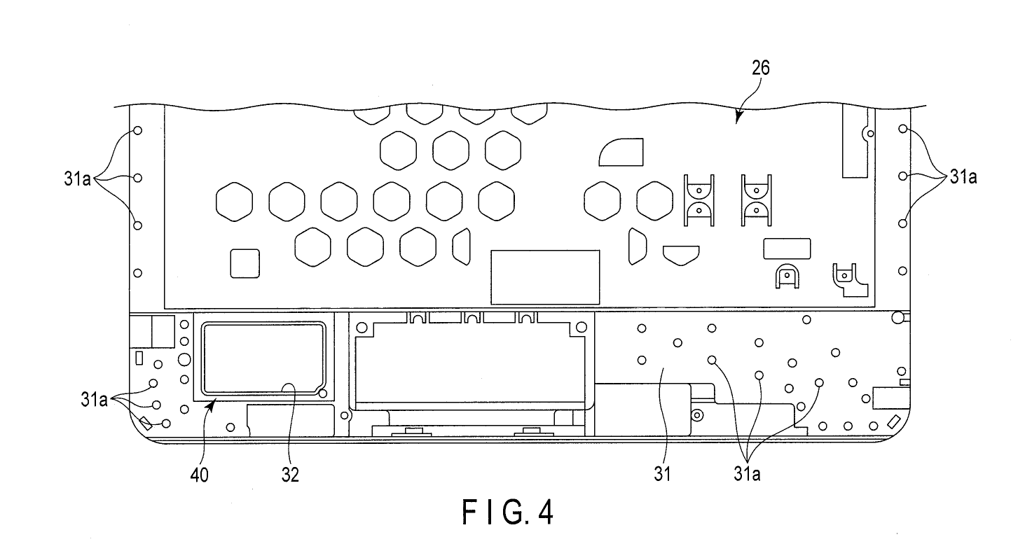

FIG. 4 is a plan view illustrating the middle frame 26. The supporting wall 31 of the middle frame 26 extends substantially over the total width of the first housing 2. The supporting wall 31 extends below, for example, the keyboard 15 and the palm rests 19a and 19b.

A plurality of pins (e.g., welding pins) which protrude toward the inside of the housing 2 are provided on the inner surface of the upper wall 12. A plurality of holes 31a into which the pins are inserted are provided in the supporting wall 31 of the middle frame 26. The pins pass through the holes 31a of the supporting wall 31 and then are welded to the supporting wall 31. In this way, the middle frame 26 is fixed to the inner surface of the upper wall 12. The supporting wall 31 includes a portion which comes into contact with the inner surface of the upper wall 12 and supports the housing 2 from the inside of the housing 2.

As illustrated in FIG. 4, an opening 32 (i.e., first opening) is provided in the supporting wall 31. The opening 32 is disposed below the palm rest 19a and faces the palm rest 19a. The opening 32 is disposed between the touchpad unit 16 and the first sidewall 13c. The opening 32 is an example of a “cut portion” in which the antenna 25 is accommodated. The “cut portion” is not limited to the opening 32, but may be a cutout portion which is provided at the end of the supporting wall 31. That is, one or two sides of the opening 32 may be opened. For example, the opening 32 may have a size of 53.0 mm×32.3 mm to 80 mm×50 mm. However, the size of the opening 32 is not limited thereto.

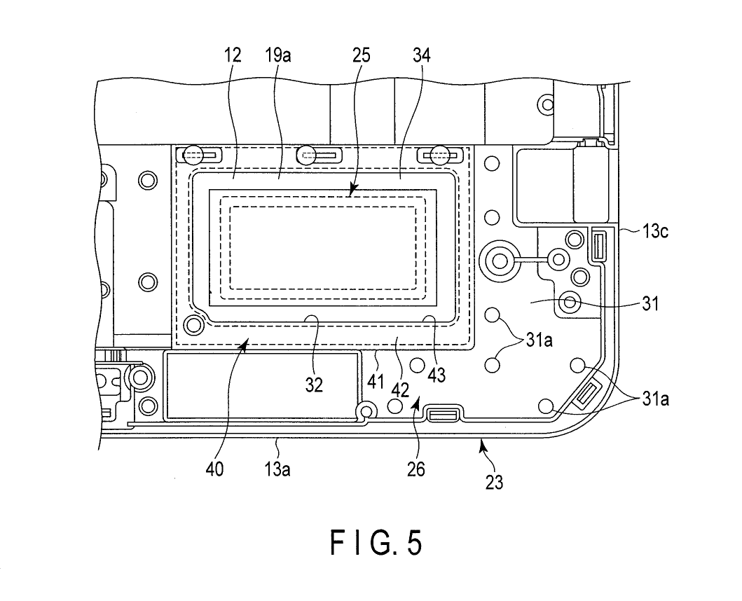

FIG. 5 illustrates the inner surfaces of the upper cover 23 and the middle frame 26 when the upper cover 23 and the middle frame 26 are combined with each other. As illustrated in FIG. 5, a portion of the upper cover 23 (i.e., upper wall 12) is exposed to the inside of the housing 2 through the opening 32. The portion which is exposed to the inside of the housing 2 through the opening 32 is an example of a “non-conductive portion 34”.

As illustrated in FIGS. 2 and 3, the antenna 25 is accommodated in the housing 2. The antenna 25 is a near-field wireless antenna and is, for example, a near-field wireless communication antenna. The “near-field wireless antenna” is not limited to a communication antenna, but may be, for example, a wireless power supply (i.e., non-contact power supply) antenna which wirelessly transmits or receives electromagnetic energy to or from an antenna of an external apparatus. In the specification, the “near-field wireless antenna” means an antenna that electrically or magnetically coupled to an antenna (see FIG. 2) of another module M which faces (e.g., is close to) the antenna 25 from the outside of the housing 2 and performs wireless transmission to the module M using the coupling.

It is expected that the antenna 25 will perform wireless exchange, for example, only in a specific direction (e.g., an upward direction). The antenna 25 according to this embodiment is an NFC (Near Field Communication) antenna and is, for example, a Felica (trademark) or TransferJet (trademark) antenna. The wireless coverage of the antenna 25 is, for example, about 10 cm and the frequency thereof is, for example, 13.56 MHz. In the following example, the antenna 25 is a loop antenna. In the case where the antenna 25 is, for example, a TransferJet antenna, the shape of the antenna may not be a loop.

As illustrated in FIG. 2, the antenna 25 faces the inner surface of the upper wall 12 from the inside of the housing 2. The antenna 25 faces the non-conductive portion 34 from the inside of the housing 2. The antenna 25 is disposed between the non-conductive portion 34 and the battery 6 (i.e., the component including the metal portion). The case 6a (e.g., metal portion) of the battery 6 covers, for example, the entire lower side of the antenna 25.

As illustrated in FIGS. 2 and 3, an insulating magnetic sheet 35 (i.e., magnetic member) is provided between the antenna 25 and the battery 6. The magnetic sheet 35 is larger than the antenna 25 and covers, for example, the entire lower side of the antenna 25. An example of the magnetic sheet 35 is a ferrite sheet. The magnetic sheet 35 reduces the influence of the metal portion of the battery 6 on the performance of the antenna 25 and improves the performance of the antenna 25. The antenna 25 is, for example, a loop antenna which is formed on a flexible board. The magnetic sheet 35 is attached to, for example, the rear surface of the flexible board.

As illustrated in FIG. 5, the antenna 25 is faces a region inside the opening 32 of the middle frame 26. The antenna 25 is disposed in the region inside the opening 32. That is, the antenna 25 is attached to the inner surface of the upper wall 12 in the opening 32. In this way, as illustrated in FIGS. 2, 3, and 5, a conductive sidewall 40 (a conductive portion, a metal portion, a ground portion, or a shielding portion) which surrounds the antenna 25 is provided around the antenna 25. The sidewall 40 covers the antenna 25 in a direction different from the battery 6.

The term “disposed in the region inside the opening” is not limited to “being disposed in the opening”, but includes a case in which the antenna passes through the opening and is attached to the inner surface of the housing. That is, the term “disposed in the region inside the opening” means that the antenna is disposed in the opening (i.e., the antenna is exposed to the inside of the housing through the opening) in a plan view of the inner surface of the housing and the opening.

Next, the shape of the sidewall 40 according to this embodiment will be described in detail. As illustrated in FIGS. 2, 3, and 5, the sidewall 40 includes a first rising wall 41 (i.e., first portion), a connection wall 42 (i.e., second portion), and a second rising wall 43 (i.e., third portion). The first rising wall 41 extends from the inner surface of the housing 2 in the thickness direction of the housing 2. That is, the first rising wall 41 extends in a direction intersecting (e.g., substantially perpendicular to) the non-conductive portion 34. The first rising wall 41 has a frame shape which surrounds the antenna 25.

The connection wall 42 is bent from the end (e.g., the lower end) of the first rising wall 41 and extends in a direction substantially parallel to the non-conductive portion 34. The connection wall 42 extends from the end of the first rising wall 41 to the opening 32. The connection wall 42 connects the end of the first rising wall 41 and the end of the second rising wall 43.

The connection wall 42 faces the case 6a of the battery 6 and extends substantially in parallel to the case 6a of the battery 6. A gap g2 between the connection wall 42 and the battery 6 is small and is less than, for example, the thickness of the upper cover 23. The gap g2 between the connection wall 42 and the battery 6 is less than, for example, the thickness of the supporting wall 31 of the middle frame 26. That is, a spatial path which connects the periphery of the antenna 25 and another region in the housing 2 is narrowed by the conductive connection wall 42 and the case 6a (i.e., metal portion) of the battery 6.

The second rising wall 43 is bent from the end of the connection wall 42 toward the inner surface of the housing 2 and extends in the thickness direction of the housing 2. That is, the second rising wall 43 extends in a direction intersecting (e.g., substantially perpendicular to) the non-conductive portion 34. The second rising wall 43 has a frame shape which surrounds the antenna 25. That is, a double wall structure (a double shielding structure) of the first rising wall 41 and the second rising wall 43 is provided around the antenna 25.

As illustrated in FIGS. 2 and 3, the second rising wall 43 forms the inner circumferential surface of the opening portion 32. That is, at least a portion of the sidewall 40 is formed by the inner circumferential surface of the opening 32. In this embodiment, a portion of the sidewall 40 is formed by the inner circumferential surface of the opening 32. However, instead of this structure, the entire sidewall 40 may be formed by the inner circumferential surface of the opening 32.

As illustrated in FIGS. 2 and 3, each of the lower ends of the first rising wall 41 and the second rising wall 43 is closer to the battery 6 than the antenna 25. That is, the connection wall 42 is closer to the battery 6 than the antenna 25. In this way, the lower side of the antenna 25 and the side edges thereof in all directions are covered by the battery 6 and the sidewall 40.

As illustrated in FIGS. 2 and 3, the antenna 25 is attached to the inner surface of the upper wall 12 by, for example, an adhesive or a double-sided tape. Therefore, the upper surface of the antenna 25 is disposed substantially in the same plane as the upper surface of the supporting wall 31 of the middle frame 26. That is, the distances of the antenna 25 and the supporting wall 31 of the middle frame 26 from the inner surface of the housing 2 are substantially equal to each other. The term “disposed substantially in the same plane as the upper surface of the supporting wall of the middle frame” includes a case in which the upper surface of the antenna 25 and the upper surface of the supporting wall 31 of the middle frame 26 have a height difference corresponding to the thickness of the adhesive which is provided between the antenna 25 and the inner surface of the housing 2. In addition, the antenna 25 may be closer to the inner surface of the housing 2 than the supporting wall 31 of the middle frame 26.

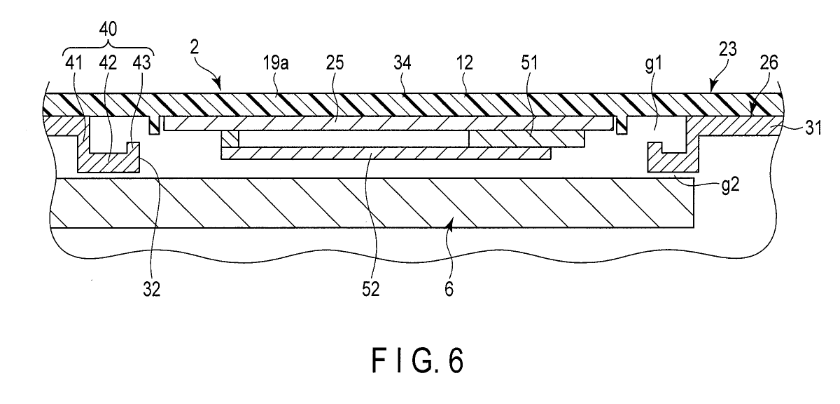

FIG. 6 is a schematic diagram illustrating the structure of this embodiment. As illustrated in FIG. 6, the second rising wall 43 does not reach the inner surface of the housing 2. A gap g1 is provided between the second rising wall 43 and the inner surface of the housing 2. Therefore, the antenna 25 is closer to the inner surface of the housing 2 than the second rising wall 43. In this embodiment, the upper end of the second rising wall 43 is disposed below the lower surface of the antenna 25.

As illustrated in FIG. 6, the electronic apparatus 1 includes an antenna module 51 and a cable 52. The antenna module 51 is, for example, a communication module, is electrically connected to the antenna 25, and operates the antenna 25. The cable 52 (i.e., antenna cable) is, for example, a coaxial cable, extends between the antenna 25 and the antenna module 51, and connects them. In this embodiment, the antenna module 51 and the cable 52 are disposed in a region inside the opening 32 of the middle frame 26.

The middle frame 26 is electrically connected to the ground of the electronic apparatus 1 and is at a ground potential. The ground of the antenna 25 is electrically connected to the middle frame 26. In this way, the ground of the antenna 25 is reinforced and radiation resistance is reduced.

According to the electronic apparatus 1 having the above-mentioned structure, it is possible to reduce noise. That is, the circuit board 5 or other electronic components which generate (i.e., release) noise are provided in the electronic apparatus 1. When the influence of noise is large, the noise is secondarily radiated through the antenna 25 and the communication performance of the antenna 25 is likely to deteriorate.

In this embodiment, the electronic apparatus 1 includes the housing 2 having the non-conductive portion 34, a component (e.g., the battery 6) which is accommodated in the housing 2 and comprises the metal portion, the near-field wireless antenna 25 which faces the non-conductive portion 34 in the housing 2 and is located between the non-conductive portion 34 and the component, and the conductive sidewall 40 which is provided in at least a portion of the periphery of the antenna 25. According to this structure, since the periphery of the antenna 25 is covered by the conductive sidewall 40, it is possible to reduce the influence of noise from another component (e.g., the circuit board 5) in the housing 2. Therefore, noise is less likely to be secondarily radiated from the antenna 25 and it is possible to reduce the amount of noise radiated from the electronic apparatus 1. This contributes to improving the communication performance of the antenna 25.

In this embodiment, the antenna 25 is located between the non-conductive portion 34 and the battery 6. The conductive sidewall 40 covers the periphery of the antenna 25 in a direction different from the battery 6. According to this structure, it is possible to cover the antenna 25 with conductive members, that is, the metal portion of the battery 6 and the conductive sidewall 40 in all directions except for the radiation direction (e.g., the upward direction) of the antenna 25. According to this structure, it is possible to further reduce the influence of noise on the antenna 25.

In this embodiment, the electronic apparatus further includes the metal middle frame 26 including the supporting wall 31 which extends along the inner surface of the housing 2 and the supporting wall 31 comprises the opening 32. The antenna 25 faces the region inside the opening 32 of the middle frame 26. At least a portion of the sidewall 40 is formed by the inner circumferential surface of the opening 32. That is, according to this structure, the sidewall 40 is formed by the middle frame 26 which improves the rigidity of the housing 2. In this way, an additional metal member or an additional conductive process required to form the sidewall 40 may not be provided. Therefore, it is possible to avoid an increase in the manufacturing costs of the electronic apparatus 1.

In the case where the supporting wall 31 of the middle frame 26 is closer to the inner surface of the housing 2 than the antenna 25, a module M, which is a wireless communication partner approached from the outside of the housing, approaches the supporting wall 31 of the middle frame 26 prior to the antenna 25, which makes it difficult to perform wireless communication.

In this embodiment, the antenna 25 is attached to the inner surface of the housing 2. The antenna 25 is closer to the inner surface of the housing 2 than the supporting wall 31 of the middle frame 26 or the distances of the antenna 25 and the supporting wall 31 from the inner surface of the housing 2 are substantially equal to each other. Therefore, the antenna 25 is less likely to be affected by the supporting wall 31 of the middle frame 26 and can stably perform wireless transmission.

In this embodiment, the sidewall 40 includes the rising wall 43 which is formed by the inner circumferential surface of the opening 32. The gap g1 is provided between the rising wall 43 and the inner surface of the housing 2. The antenna 25 is closer to the inner surface of the housing 2 than the rising wall 43. According to this structure, the antenna 25 is less likely to be affected by the middle frame 26 and can stably perform wireless transmission.

### Second Embodiment

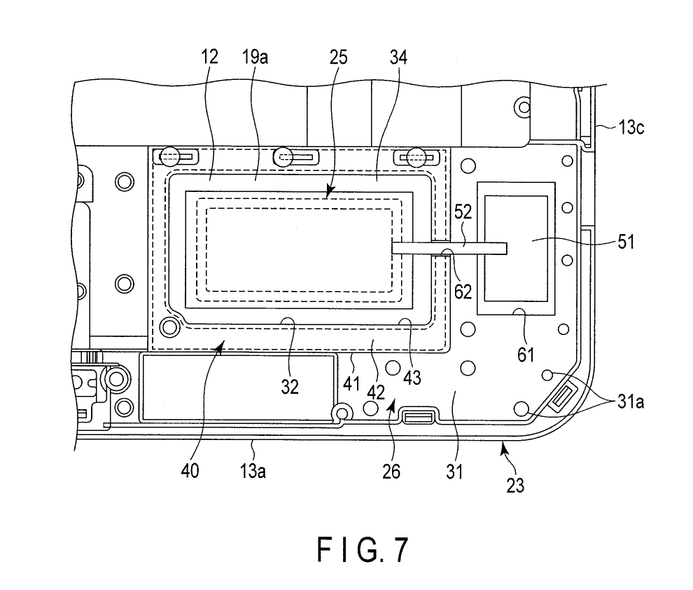

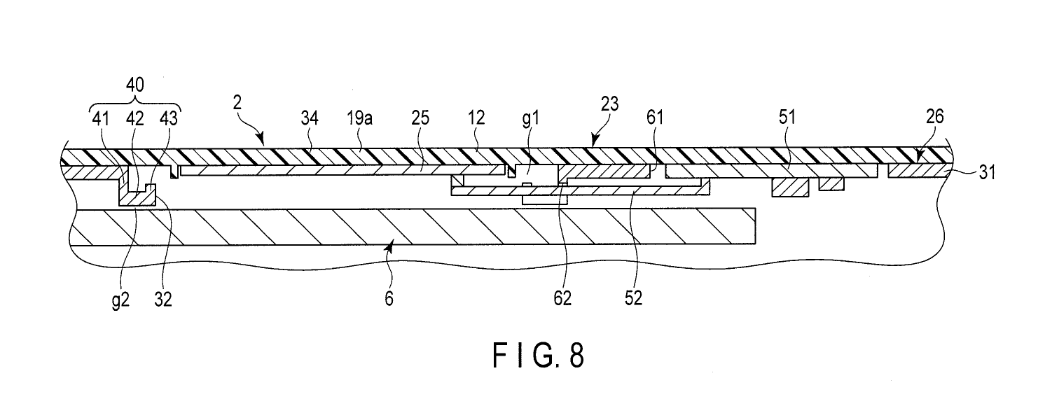

Next, an electronic apparatus 1 according to a second embodiment will be described with reference to FIGS. 7 and 8. In the second embodiment, components having the same or similar functions as those in the first embodiment are denoted by the same reference numerals and the description thereof will not be repeated. In addition, structures other than the following structures are the same as those in the first embodiment.

As illustrated in FIG. 7, in this embodiment, an antenna module 51 is provided outside a sidewall 40. Specifically, another opening 61 (i.e., second opening) is provided in a supporting wall 31 of a middle frame 26. The antenna module 51 is disposed in the opening 61. The antenna module 51 is attached to the inner surface of a housing 2 through the opening 61. The ground of the antenna module 51 is electrically connected to the middle frame 26.

As illustrated in FIGS. 7 and 8, a cable 52 extends between the antenna 25 and the antenna module 51. A recess 62 through which the cable 52 passes is provided in the sidewall 40 around the antenna 25. The cable 52 passes through the recess 62 to connect the inside and outside of the sidewall 40.

According to this structure, similarly to the first embodiment, it is possible to reduce the noise of the electronic apparatus 1. Furthermore, in this embodiment, the antenna module 51 is provided outside the sidewall 40. According to this structure, the antenna 25 is less likely to be affected by the antenna module 51 and can stably perform wireless transmission.

In this embodiment, the recess 62 through which the cable 52 passes is provided in the sidewall 40. According to this structure, the lower end of the sidewall 40 can be arranged close to the battery 6, without being affected by the diameter of the cable 52. That is, it is possible to narrow the gap g2 between the leading end of the sidewall 40 and the metal portion of the battery 6. According to this structure, the antenna 25 is less likely to be affected by the antenna module 51 or other electronic components and can stably perform wireless transmission. For example, the gap g2 between the leading end of the sidewall 40 and the metal portion of the battery 6 is less than the diameter of the cable 52.

In this embodiment, the middle frame 26 includes another opening 61 which is provided in the supporting wall 31 and is accommodated in the antenna module 51. According to this structure, a conductive sidewall which surrounds the antenna module 51 is formed by the inner circumferential surface of the opening 61. Therefore, noise generated from the antenna module 51 is less likely to be transmitted to the antenna 25. In addition, when the antenna module 51 is arranged in the opening 61, it is possible to reduce the thickness of the electronic apparatus 1.

### Third Embodiment

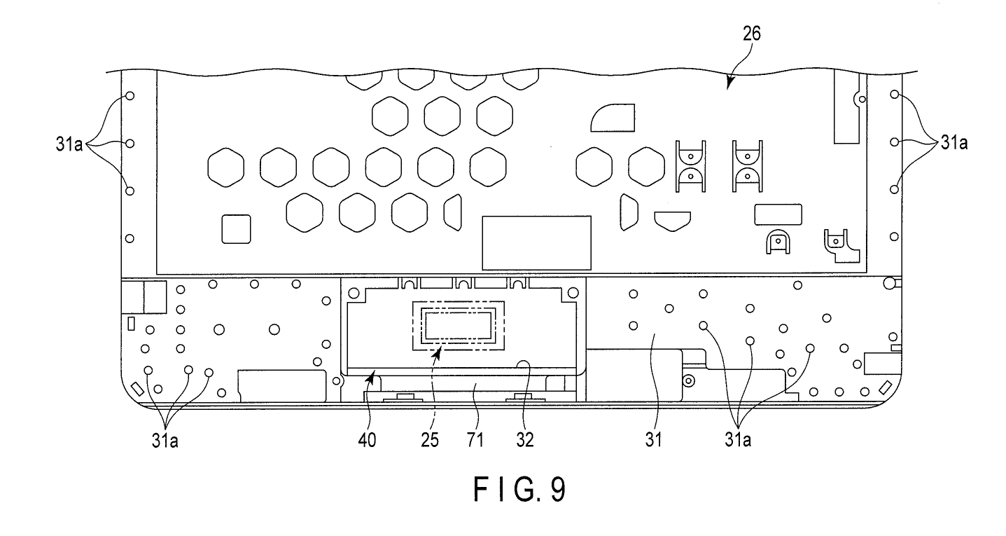

Next, an electronic apparatus 1 according to a third embodiment will be described with reference to FIG. 9. In the third embodiment, components having the same or similar functions as those in the first embodiment are denoted by the same reference numerals and the description thereof will not be repeated. In addition, structures other than the following structures are the same as those in the first embodiment.

In this embodiment, an opening 72 to which a touchpad unit 16 is attached is provided in an upper wall 12 of a housing 2 (see FIG. 1). The opening 72 is an example of a “non-conductive portion”. An opening 32 is provided in a middle frame 26 below the touchpad unit 16. An antenna 25 is provided in a region inside the opening 32 and faces the touchpad unit 16 from the lower side. The antenna 25 performs wireless transmission to a module M, which is a wireless transmission partner, with the touchpad unit 16 interposed therebetween.

Similarly to the first embodiment, a sidewall 40 which surrounds the antenna 25 is provided in the middle frame 26. The inner circumferential surface of the opening 32 of the middle frame 26 forms at least a portion of the sidewall 40.

Similarly to the first embodiment, the touchpad unit 16 includes a button module 18. As illustrated in FIG. 9, the supporting wall 31 of the middle frame 26 includes a supporting portion 71 which is provided below the button module 18 and supports the button module 18 from the lower side. When the user presses the button module 18, the supporting wall 31 supports the button module 18 from the lower side to generate hit feeling.

According to this structure, similarly to the first embodiment, it is possible to reduce the noise of the electronic apparatus 1. Furthermore, in this embodiment, the opening 32 of the middle frame 26 is provided below the touchpad unit 16. The antenna 25 faces the touchpad unit 16.

That is, according to this structure, it is possible to provide the conductive sidewall 40 around the antenna 25 using the opening 32 provided below the touchpad unit 16. In other words, unlike the first embodiment, it is not necessary to provide the opening 32 of the middle frame 26 below a palm rest 9a. Therefore, the strength of the middle frame 26 is improved. That is, it is possible to further improve the rigidity of the housing 2.

In this embodiment, the touchpad unit 16 includes the button module 18. The supporting wall 31 of the middle frame 26 includes the supporting portion 71 which supports the button module 18. According to this structure, it is possible to provide the conductive sidewall 40 around the antenna 25 using the middle frame 26 which ensures the hit feeling of the button module 18. Therefore, an additional metal member or an additional conductive process required to form the sidewall 40 may not be provided.

The embodiments are not limited to the above-described embodiments, but the components according to the above-described embodiments may be changed without departing from the scope and spirit of the invention. In addition, a plurality of components according to the above-described embodiments may be appropriately combined with each other to form various structures. For example, some components may be removed from all components according to the above-described embodiments. In addition, components according to different embodiments may be appropriately combined with each other.

For example, in the above-described embodiments, the conductive sidewall 40 is provided in the middle frame 26. However, the embodiments are not limited thereto. For example, the conductive sidewall 40 may be formed by providing a conductive treatment for a protrusion (e.g., a rib) which is provided on the inner surface of a non-conductive housing 2. Examples of the conductive treatment include conductive coating, plating, and the attachment of metal foil. In addition, the conductive sidewall 40 may be formed by a protrusion (e.g., a rib) which is provided on the inner surface of a metal housing 2 or on a shield metal plate accommodated in the housing 2.

The sidewall 40 does not necessarily surround the entire antenna 25, but may be provided in a portion of the periphery of the antenna 25. A portion of the sidewall 40 in a direction in which the influence of noise is small may be removed based on, for example, the shape or size of the antenna 25 and the mounting position of the antenna 25 relative to the battery 6. For example, when the antenna 25 is close to a component which is accommodated in the housing 2 and generates noise, the influence of noise is large. Therefore, it is necessary to provide the conductive sidewall 40 in the direction in which the influence of noise is large. On the other hand, when the antenna 25 is far away from the component which is accommodated in the housing 2 and generates noise, the conductive sidewall 40 may not be provided in that direction.

The positions where the antenna 25, the battery 6, and the conductive sidewall 40 are provided are not limited to the palm rests 19a and 19b, but may be a frame cover (i.e., a front cover, a bezel, or a mask) of a tablet portable computer or a bottom cover (i.e., rear cover) of an electronic apparatus. The member covering the lower side of the antenna 25 is not limited to the battery 6, but may be, for example, a hard disk drive, an optical disk drive, a circuit board, or other modules.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing comprising a non-conductive portion;
a battery in the housing;
a near-field wireless antenna between the non-conductive portion and the battery and facing the non-conductive portion in the housing;
a magnetic sheet between the antenna and the battery; and
a conductive sidewall surrounding a periphery of the antenna.

2. The electronic apparatus of claim 1, further comprising:
a metal reinforcing member comprising a supporting wall extending along an inner surface of the housing, the supporting wall comprising a first opening,
wherein the antenna faces a region inside the first opening, and
an inner circumferential surface of the first opening comprises at least a portion of the sidewall.

3. The electronic apparatus of claim 2,
wherein the antenna is attached to the inner surface of the housing, and
the antenna is closer to the inner surface of the housing than the supporting wall.

4. The electronic apparatus of claim 2,
wherein the antenna is attached to the inner surface of the housing, and
a first distance between the antenna and the inner surface of the housing is substantially equal to a second distance between the supporting wall and the inner surface of the housing.

5. The electronic apparatus of claim 2,
wherein the sidewall comprises a rising wall forming the inner circumferential surface of the first opening,
a gap is defined between the rising wall and the inner surface of the housing, and
the antenna is closer to the inner surface of the housing than the rising wall.

6. The electronic apparatus of claim 2, further comprising:
an antenna circuit outside the sidewall electrically connected to the antenna.

7. The electronic apparatus of claim 6, further comprising:
a cable connecting the antenna and the antenna circuit,
wherein the sidewall comprises a recess through which the cable passes.

8. The electronic apparatus of claim 6,
wherein the supporting wall comprises a second opening, the antenna circuit in the second opening.

9. The electronic apparatus of claim 2, further comprising:
a touchpad unit in the housing,
wherein the non-conductive portion is an opening to which the touchpad unit is attached,
the first opening of the reinforcing member is below the touchpad unit, and
the antenna faces the touchpad unit.

10. The electronic apparatus of claim 9,
wherein the touchpad unit comprises a button module, and
the supporting wall comprises a supporting portion configured to support the button module.

11. An electronic apparatus comprising:
a housing comprising a non-conductive portion;
a component in the housing, the component comprising a metal portion;
a near-field wireless antenna between the non-conductive portion and the component and facing the non-conductive portion in the housing, and
a conductive sidewall in at least a portion of a periphery of the antenna.
